(19) United States
(12) Patent Application Publication
(10) Pub. No.: US 2026/0186940 A1
(43) Pub. Date: Jul. 2, 2026

(54) IMPROVED AUTOSCALING FOR BURSTY TRAFFIC

(71) Applicant: Intuit Inc., Mountain View, CA (US)

(72) Inventors: Xiaotang SHAO, Cupertino, CA (US); Hui LUO, Fremont, CA (US); Zihan JIANG, Foster City, CA (US); Sen LIN, Mountain View, CA (US); Navin Kumar JAMMULA, Dublin, CA (US); Venkata Sukumar Reddy GUNAPATI, Dublin, CA (US); Yuxuan ZHU, Mountain View, CA (US); Todd Edward EKENSTAM, Thousand Oaks, CA (US); Estela RAMIREZ, Mountain View, CA (US); Chun-Che PENG, San Diego, CA (US); Rajesh Shekhar SHETTY, San Diego, CA (US)

(73) Assignee: Intuit Inc., Mountain View, CA (US)

(21) Appl. No.: 19/006,165

(22) Filed: Dec. 30, 2024

(51) Int. Cl. G06F 11/34; G06F 9/50

(52) U.S. Cl. CPC G06F 11/3433; G06F 9/5083; G06F 11/3419

(57) ABSTRACT

A method of improving autoscaling for bursty traffic. A performance metric is received and used by an autoscaling controller to scale a number of deployed processes. The performance metric is compared to a pre-existing target. When the performance metric exceeds the pre-existing target, the number of deployed processes is determined to be increased based on a curved metric. The curved metric is generated by applying a curve function to the performance metric, which prescales the number of deployed processes. The autoscaling controller then increases the number of deployed processes based on the curved metric.

### BACKGROUND

Autoscaling controllers, such as horizonal pod autoscaling controllers, scale services such as processes when the traffic using the processes increases or decreases. Autoscaling controllers may be used to, for example, prevent an application (e.g., a website) from crashing during an increase in traffic to the processes.

There does not exist an autoscaling controller that adjust the processes based on process parameters such as process startup times or a number of ready processes. As a result, a problem exists where conventional autoscaling controllers using standard metrics cannot scale fast enough when a surge in traffic occurs in a short duration of time as processes with longer startup times may not be fast enough to deploy during the surge. In such instance, the processes become overloaded and terminate, resulting in the application crashing. Thus, there is no conventional autoscaling controllers that can scale fast enough or adequately to handle unexpectedly high bursts in traffic (also known as “bursty traffic”).

The outlined technical problem may present a particular difficulty in applications that experience these unexpected bursts in traffic. Further, such surges cannot be anticipated as customer/user behavior is unpredictable. For example, an application such as a website may experience unexpected bursts in traffic after a celebrity endorses or mentions the website. In such instances, the processes terminate when overloaded and the website crashes, leading end users unable to access the website. However, conventional autoscaling controllers either cannot scale fast enough or are costly to implement for bursty traffic. For example, a conventional autoscaling controller may have a slow ramp up time that cannot keep up with short bursts in traffic. In another example, an autoscaling controller may simply increase and hold the number of processes deployed regardless of whether bursty traffic is detected, which leads to an increase in costs.

Thus, a technical problem exists, specifically developing an autoscaling controller that adequately scales processes during bursty traffic using additional information such as, for example, the process startup time or the number of ready processes. Additionally, efforts are being made to improve the autoscaling controller in a cost-effective manner.

### SUMMARY

One or more embodiments provide for a method of improving autoscaling for bursty traffic. The method includes receiving a performance metric. The performance metric is used by an autoscaling controller to scale a number of deployed processes by at least one of increasing the number of deployed processes in response to the performance metric exceeding a pre-existing target and decreasing the number of deployed processes in response to performance metric being below the pre-existing target. The autoscaling controller is incapable of scaling the number of deployed processes using the performance metric to prevent a deployed process from terminating during bursty traffic. The method also includes comparing the performance metric to the pre-existing target. The method also includes determining, when the performance metric exceeds the pre-existing target, to increase the number of deployed processes based on a curved metric. The method also includes receiving the curved metric, where the curved metric is generated by applying a curve function to the performance metric. The curve function prescales the number of deployed processes and prescaling the number of deployed processes prevents the deployed process from terminating during the bursty traffic. The method also includes increasing, by the autoscaling controller, the number of deployed processes based on the curved metric.

One or more embodiments also provide for a system of improving autoscaling for bursty traffic. The system includes a computer processor and a metrics server in communication with the computer processor. The system also includes a data repository in communication with the computer processor. The data repository stores a pre-existing target, a curved metric, and a curve function. The system also includes a deployed process in communication with the metrics server and the data repository and having a performance metric and a number of deployed processes. The system also includes an autoscaling controller which, when executed by the computer processor, performs at least one of increasing and decreasing the number of deployed processes. The system also includes a server controller which, when executed by the computer processor: receives the performance metric; compares the performance metric to the pre-existing target; and receives the curved metric. The curved metric is generated by applying a curve function to the performance metric and the curve function prescales the number of deployed processes.

One or more embodiments also provide for a method of improving autoscaling for bursty traffic. The method includes receiving a performance metric. The performance metric is used by an autoscaling controller to scale a number of deployed processes by at least one of increasing the number of deployed processes in response to the performance metric exceeding a pre-existing target and decreasing the number of deployed processes in response to performance metric being below the pre-existing target. The method also includes comparing the performance metric to the pre-existing target and determining, when the performance metric is below the pre-existing target, to decrease the number of deployed processes based on a curved metric. The method also includes receiving the curved metric where the curved metric is generated by applying a curve function to the performance metric. The curve function prescales the number of deployed processes. The method also includes decreasing, by the autoscaling controller, the number of deployed processes based on the curved metric.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart in accordance with one or more embodiments.

FIG. 3 shows an example of dataflow in accordance with one or more embodiments.

FIG. 4A and FIG. 4B show an example of a computing system, in accordance with one or more embodiments.

Like elements in the various figures are denoted by like reference numerals for consistency.

### DETAILED DESCRIPTION

One or more embodiments are directed to an improved autoscaling controller for bursty traffic. The improved autoscaling controller solves at least the above-mentioned technical problem. The technical problem, again, is developing an autoscaling controller that can adequately scale processes during bursty traffic.

One or more embodiments receive a performance metric that is used to determine if traffic to an application (e.g., a website) has increased or decreased and subsequently, whether a number of deployed processes is to be increased or decreased. The deployed processes are processes that can run the application. However, if a deployed process becomes overloaded, the deployed process may terminate. Thus, if there are not enough deployed processes, some or all of the deployed processes may terminate and result in the application crashing.

To prevent such termination, the performance metric is compared to a pre-existing target, which indicates if traffic is steady, increasing, or decreasing. More specifically, when the performance metric is above the pre-existing target, the traffic is increasing, when the performance metric is below the pre-existing target, the traffic is decreasing, and when the performance metric is equal to the pre-existing target, the traffic is steady.

The comparison is then used to determine if the number of deployed processes is to be increased or decreased. More specifically, the number of deployed processes is increased in response to the performance metric exceeding the pre-existing target and decreased in response to performance metric being below the pre-existing target. When the performance metric exceeds the pre-existing target, a server controller determines that the number of deployed processes is to be increased based on a curved metric.

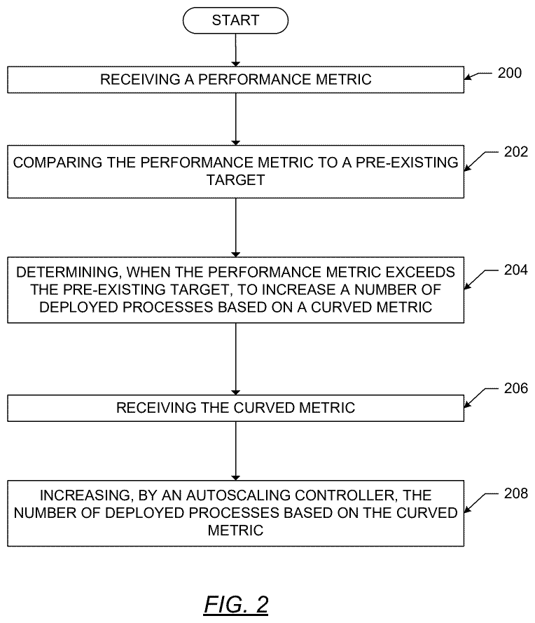

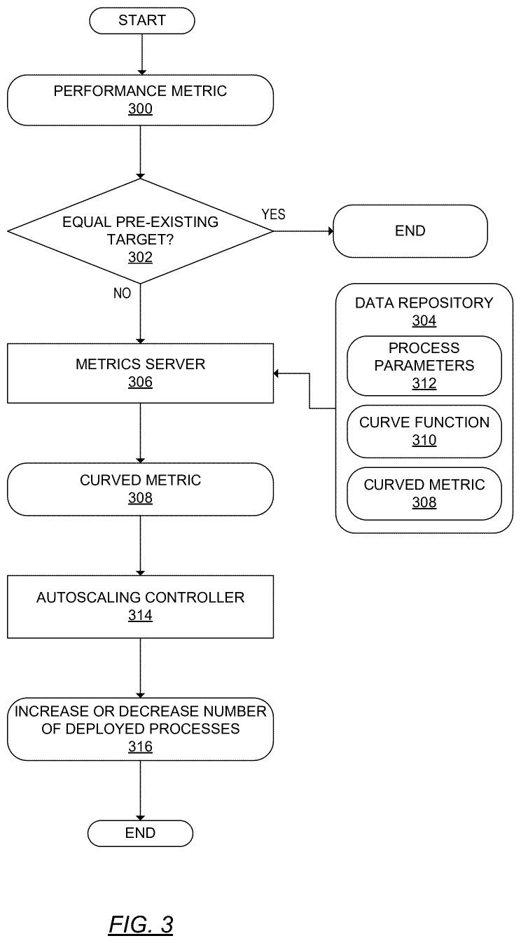

The curved metric is the performance metric with a curve function applied to the performance metric. The curved metric takes into account a number of ready processes and a startup time of the processes. The curved metric, when used to calculate the number of deployed processes, generally results in a higher number of deployed processes for processes with longer startup times as compared to when the performance metric (without the curve function applied) is used to calculate the number of deployed processes. In other words, the curved metric prescales and increases the number of deployed processes earlier so as to allow processes with a higher startup time more time to startup, as will be discussed in detail in FIGS. 2 and 3.

Lastly, the number of deployed processes is increased based on the curved metric. More specifically, the number of deployed processes is calculated using the curved metric and the pre-existing target. Thus, one or more embodiments provide a practical application as a solution to the technical problem: by increasing the number of deployed processes earlier, more deployed processes are in place to accommodate bursty traffic.

As a specific example, the performance metric may be CPU usage, the pre-existing target may be 50% CPU usage, and the number of deployed processes may be two processes. When the CPU usage is 60% and thus, above the pre-existing target of 50% CPU usage, the CPU usage of 60% is curved using the curve function to generate the curved CPU usage of 70%. The curve function may be based on, for example, a number of ready processes of two processes and a process startup time of two minutes. The curved CPU usage of 70% and the pre-existing target CPU usage of 50% are then used to calculate the number of deployed processes which may equal, for example, seven processes. As such, the number of deployed processes is increased from two to seven processes. In such example, if the number of deployed processes was calculated using the CPU usage of 60%, then the number of deployed processes would be lower at, for example, five processes, which may not be enough processes to handle a quick increase in CPU usage. Thus, the curved CPU usage improves the autoscaling controller by increasing the number of deployed processes earlier as compared to the CPU usage without the curve function applied.

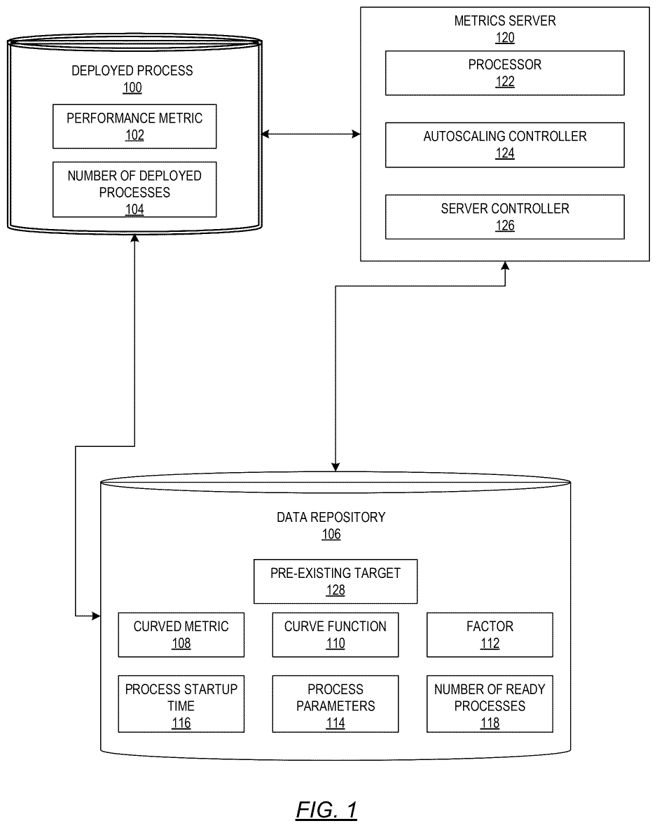

Attention is now turned to the figures. FIG. 1 shows a computing system, in accordance with one or more embodiments. The system shown in FIG. 1 includes a deployed process (100). The deployed process (100) is a process that is deployed and ready to run an application workload. In some embodiments, the deployed process is a deployed pod. In such embodiments, the deployed pod includes one or more containers with shared storage and network resources. Each container of the one or more container includes code and runtimes to run an application workload.

A performance metric (102) is obtained or scraped from the deployed process (100). The performance metric (102) is a measurement of a quantifiable computing characteristic. For example, the performance metric (102) can be CPU usage, average bandwidth, available core time, etc. The performance metric (102) can be a numerical value, a percentage, or proportion. The performance metric (102) can be monitored continuously or at pre-determined time intervals.

The performance metric (102) may be a performance metric developed or defined by, for example, a user. In other examples, the performance metric (102) may be a performance metric automatically defined by, for example a processor (122).

A number of deployed processes (104) is also obtained or scraped from the deployed process (100). The number of deployed processes (104) is a numerical value describing the number of processes that are deployed and ready to run an application. The number of deployed processes (104) can be increased or decreased by an autoscaling controller (124) (described below).

The system also includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a pre-existing target (128). The pre-existing target (128) corresponds to a target value of the performance metric (102). When the performance metric (102) is above the pre-existing target (128), this indicates an increase in traffic, when the performance metric (102) is below the pre-existing target (128), this indicates a decrease in traffic, and when the performance metric (102) is equal to the pre-existing target (128), this indicates that the traffic is steady. The pre-existing target (128) can be a numerical value, a percentage, or proportion.

The data repository (106) also stores a curved metric (108). The curved metric (108) is the performance metric (102) with a curve function (110) (described below) applied to the performance metric (102). The curved metric (108) results in a higher number of deployed processes (104) as compared to the performance metric (102) when increased traffic is detected. Use and generation of the curved metric (108) will be described in detail in FIGS. 2 and 3.

The data repository (106) also stores the curve function (110). The curve function (110) is a function that is applied to the performance metric (102) to generate the curved metric (108). The curve function (110) is based on a process parameter (114) and may include a factor (112) that is also determined based on the process parameter (114) (described below).

The data repository (106) also stores the factor (112). The factor (112) is a numerical value that correlates with a range of process startup times (116). For example, a first factor correlates to a first range of process startup times and a second factor correlates to a second range of process startup times. Generally, the factors increase in value as the range of process startup times increases. In other embodiments, the factor (112) may be determined from a function of the process startup times.

The data repository (106) also stores the process parameter (114). The process parameter (114) is a quantifiable value of a characteristic of the process or deployed processes. For example, the process parameter (114) can be the process startup time (116), a number of ready processes (118), a number of deployed process (100), etc. The process parameter (114) may be retrieved or scraped from the deployed process (100) and stored in the data repository (106).

The data repository (106) also stores a number of ready processes (118). The number of ready processes (118) is a numerical value describing the number of processes that are ready and deployed to run an application. In other words, the number of ready processes (118) is equal to the number of deployed processes (104) and is stored in the data repository (106).

The data repository (106) also stores a process startup time (116). The process startup time (116) is the time it takes for the process to activate from a stored state to a deployed state. In other words, the process startup time (116) is the time is takes for the process to start from the stored state.

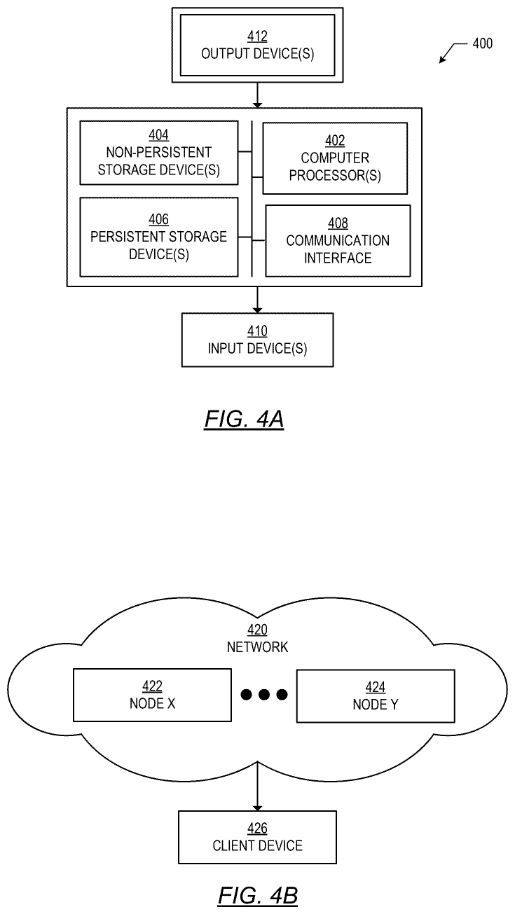

The system shown in FIG. 1A may include other components. For example, the system shown in FIG. 1A also may include a metrics server (120). The metrics server (120) is one or more computer processors, data repositories, communication devices, and supporting hardware and software. The metrics server (120) may be in a distributed computing environment. The metrics server (120) is configured to execute one or more applications, such as the autoscaling controller (124) and the server controller (126). An example of a computer system and network that may form the metrics server (120) is described with respect to FIG. 4A and FIG. 4B.

The metrics server (120) includes a computer processor (122). The computer processor (122) is one or more hardware or virtual processors which may execute computer readable program code that defines one or more applications, such as the autoscaling controller (124) and the server controller (126). An example of the computer processor (122) is described with respect to the computer processor(s) (402) of FIG. 4A.

The metrics server (120) also includes the autoscaling controller (124). The autoscaling controller (124) is software or application specific hardware which, when executed by the computer processor (122), increases or decreases the number of deployed processes based on the performance metric (102). Use of the autoscaling controller (124) is described with respect to FIGS. 2 and 3.

The metrics server (120) also may include a server controller (126). The server controller (126) is software or application specific hardware which, when executed by the computer processor (122), controls and coordinates operation of the software or application specific hardware described herein. Thus, in some embodiments, the server controller (126) may control and coordinate execution of the autoscaling controller (124).

The server controller (126) also may be programmed to perform specific steps with respect to FIG. 2. For example, the server controller (126) may receive the performance metric (102), compare the performance metric (102) to the pre-existing target (128), determine to increase the number of deployed processes (104) based on the curved metric (108), and receive the curved metric (108), as explained further with respect to FIG. 2.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for providing an improved autoscaling controller that can adequately scale processes during bursty traffic, in accordance with one or more embodiments. The method of FIG. 2 may be implemented using the system of FIG. 1 and one or more of the steps may be performed on or received at one or more computer processors.

Step 200 includes receiving a performance metric. The performance metric is received by, for example, a metrics server. The performance metric is used by an autoscaling controller to scale a number of deployed processes by increasing the number of deployed processes or decreasing the number of deployed processes. To determine whether to increase or decrease the number of deployed processes, the performance metric is compared to a pre-existing target, as described below.

Step 202 includes comparing the performance metric to the pre-existing target. The performance metric can be compared to the pre-existing target by the metrics server. In response to the performance metric being below the pre-existing target, the number of deployed processes is decreased and in response to the performance metric exceeding a pre-existing target, the number of deployed processes is increased. In embodiments where the performance metric equals the pre-existing target, then the number of deployed processes is unchanged.

Step 204 includes determining, when the performance metric exceeds the pre-existing target, to increase the number of deployed processes based on a curved metric. The metrics server may determine to increase the number of deployed processes. The number of deployed processes is increased by the autoscaling controller using the curved metric, as described below.

Step 206 includes receiving the curved metric. The curved metric can be received by the metrics server. In some embodiments, the metrics server executes a plurality of steps to receive the curved metric including querying a data repository for the curved metric and receiving the curved metric.

The curved metric is generated by applying a curve function to the performance metric. The curve function, as previously described, is a function that curves or adjusts the performance metric to generate the curved metric. More specifically, the curve function prescales the number of deployed processes to prevent the deployed processes from prematurely terminating during bursty traffic. The curve function uses a process parameter or a set of process parameters to prescale the number of deployed processes.

The process parameters can be, for example, a number of ready processes and a process startup time. The number of ready processes can be used directly in the curve function. The process startup time can be used to determine a factor used in the curve function. Generally, the factor increases the value of the performance metric as the process startup time increases. As previously described, the factor is determined either as a function of the process startup times or based on ranges of the process startup time. For example, if the process startup time falls within a first range of the ranges of the process startup time, then a corresponding first factor is used in the curve function.

Generally, the curved metric results in a higher number of deployed processes earlier in a ramp-up time than the performance metric. More specifically, in conventional methods, the performance metric and the pre-existing target are used to calculate the number of deployed processes. Such conventional method does not scale fast enough when faced with bursty traffic for various reasons. For example, processes with longer startup times may not startup fast enough and may not be deployed when the bursty traffic occurs. The performance metric does not take this into account, and thus, may try to deploy processes that cannot startup within the short time interval of the bursty traffic. On the other hand, when the curved metric and the pre-existing target are used to calculate the number of deployed processes, the number of deployed processes is generally higher than when the performance metric is used to calculate the number of deployed processes. This is due to the curved metric having a higher value than the performance metric when the process startup times are higher. In other words, the curved metric deploys more processes early so as to allow the processes with longer startup times adequate time to startup in anticipation of or in reaction to the bursty traffic.

Step 208 includes increasing, by the autoscaling controller, the number of deployed processes based on the curved metric. The number of deployed processes is calculated by the autoscaling controller using the curved metric and the pre-existing target.

In some embodiments, after the number of deployed processes is increased, the number of deployed processes may then be decreased. In such embodiments, the performance metric of the method described above is a first performance metric and the curved metric is a first curved metric. The method then may include the steps of receiving a second performance metric and comparing the second performance metric to the pre-existing target. The method may also include determining, when the second performance metric is below the pre-existing target, to decrease the number of deployed processes based on a second curved metric. The method may also include receiving the second curved metric and subsequently decreasing, using the autoscaling controller, the number of deployed processes based on the second curved metric. In such steps, the second curved metric is generated by applying a second curve function to the second performance metric.

While the various steps in this flowchart are presented and described sequentially, at least some of the steps may be executed in different orders, may be combined or omitted, and at least some of the steps may be executed in parallel. Furthermore, the steps may be performed actively or passively.

FIG. 3 shows an example dataflow of a method of providing an improved autoscaling controller that can adequately scale processes during bursty traffic. The dataflow of FIG. 3 is a variation of the method of the system shown in FIG. 1 and the method of FIG. 2. The following example is for explanatory purposes only and not intended to limit the scope of one or more embodiments.

The dataflow will be first described generally, then a specific example using the dataflow will be described in detail. As shown, a performance metric (300) is received and compared to a pre-existing target (302) to determine if the performance metric (300) exceeds the pre-existing target (302), is equal to the pre-existing target (302), or is below the pre-existing target (302). If the performance metric (300) is equal to the pre-existing target (302), then the dataflow ends. If the performance metric (300) is above or below pre-existing target (302), then the number of deployed processes (316) is increased or decreased, respectively.

A curved metric (308) is then received or generated by a metrics server (306). In some embodiments, the curved metric (308) can be generated by applying a curve function (310) to the performance metric (300). The curve function (310) and/or the parameters (312) can be received from a data repository (304). In some embodiments, the curved metric (308) can be received from the data repository (304). As previously described, the curve function (310) can incorporate one or more process parameters (312) such as a process startup time, a number of ready processes, etc.

The curved metric (308) is used by an autoscaling controller (314) to increase or decrease the number of deployed processes (316). More specifically, the curved metric (308) and the pre-existing target (302) are used to calculate a number of deployed processes (316).

In a specific example, which will be described with respect to FIG. 3, the performance metric (300) is a CPU usage, the pre-existing target (302) is a CPU target usage of 50% CPU usage, and a number of currently deployed processes is two. The CPU usage is used to measure whether an application such as, for example, a website is receiving a steady amount of traffic or is seeing an increase or a decrease in traffic to the website.

In the example, the CPU usage is compared to the CPU target usage to determine if the CPU usage is equal to, above, or below the CPU target usage. If the CPU usage is equal to 50%, then the process ends as this indicates that the traffic is at a steady level. If the CPU usage is above 50%, then the number of deployed processes (316) is increased as this indicates that traffic is increasing. In such instance, the number of deployed processes is increased to enable the deployed processes to handle the increased traffic and to prevent the currently deployed processes from terminating. If the CPU usage is below 50%, then the number of deployed processes (316) is decreased as this indicates that traffic is decreasing back to the steady level.

In such examples, if a conventional autoscaling controller is used, then a value of the CPU usage and the CPU target usage is used to calculate the number of deployed processes. For example, if the value of the CPU usage is 60% and the target CPU usage is 50%, then the number of deployed processes may be calculated as five deployed processes. Thus, the number of deployed processes may be increased from two to five deployed processes. However, such increase in the number of deployed processes may not be sufficient to handle the increase in CPU usage if the increase occurs over a short period of time (e.g., “bursty traffic”). Thus, a curved metric, which increases or scales the number of deployed processes to a higher number than the performance metric, is beneficial in such situation, as will be described below.

In the same example, when the CPU usage is at 60%, then the metrics server (306) receives or queries the data repository (304) for the curved metric (308). As previously described, the curved metric (308) is generated by applying a curve function (310) to the CPU usage to generate a curved CPU usage. In this example, the curve function (310) can be the following formula:

$$CURVE ( M [ T ] ) = M [ T ] * ( C [ T ] + F ( S ) ) / ( C [ T ] + 1 )$$

In the formula, M is the performance metric (300), M[T] is a value of the performance metric (300) at a time T, C[T] is a process parameter (312) such as a number of ready processes, and F(S) is a factor that is determined based on another process parameter (312) such as a process startup time.

In the example, the curved metric (308) is the curve function (310) applied the CPU usage of 60% to generate a curved CPU usage of, for example, 70%. The curved CPU usage of 70% and the target CPU usage of 50% is then used to calculate that the number of deployed processes, rather than the CPU usage of 60% and the target CPU usage of 50%. Such increased value in the curved CPU usage results in a number of deployed processes of, for example, seven deployed processes. As such, the number of deployed processes is increased from two to seven deployed processes.

Thus, the curved CPU usage of 70% results in a higher number of deployed processed (seven deployed processes) as compared to the CPU usage of 60% (five deployed processes). This is due to the curve function incorporating parameters such as the process startup time and the number of deployed processes. By taking such parameters into account, the autoscaling controller (314) may prescale or increase the number of deployed processes (316) earlier to accommodate longer process start times or a lower number of deployed processes. Such prescaling reduces the risk of the deployed processes from terminating during bursty traffic. For example, the number of deployed processes is increased for longer process startup times. Similarly, the number of deployed processes is increased for lower number of deployed processes. In another example, when the process startup time is fast, then the curve function may have less of an effect on the CPU usage and thus, the curved CPU usage may be close in value to the CPU usage.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a performance metric,
wherein the performance metric is used by an autoscaling controller to scale a number of deployed processes by at least one of increasing the number of deployed processes in response to the performance metric exceeding a pre-existing target and decreasing the number of deployed processes in response to performance metric being below the pre-existing target, and
wherein the autoscaling controller is incapable of scaling the number of deployed processes using the performance metric to prevent a deployed process from terminating during bursty traffic,
comparing the performance metric to the pre-existing target;
determining, when the performance metric exceeds the pre-existing target, to increase the number of deployed processes based on a curved metric;
receiving the curved metric,
wherein the curved metric is generated by applying a curve function to the performance metric,
wherein the curve function prescales the number of deployed processes, and
wherein prescaling the number of deployed processes prevents the deployed process from terminating during the bursty traffic; and
increasing, by the autoscaling controller, the number of deployed processes based on the curved metric.

2. The method of claim 1, wherein increasing the number of deployed processes based on the curved metric includes calculating the number of deployed processes using the curved metric and the pre-existing target.

3. The method of claim 1, wherein the deployed process is a deployed pod,
wherein the deployed pod contains one or more containers with shared storage and network resources, and
wherein each container of the one or more containers includes code and runtimes to run an application workload.

4. The method of claim 1, wherein the curve function includes one or more process parameters.

5. The method of claim 4, wherein receiving the curved metric includes a plurality of steps comprising:
querying a data repository for the curved metric,
querying the data repository for the performance metric and the one or more process parameters, and
transmitting the curved metric to the autoscaling controller,
wherein the performance metric and the one or more process parameters are imported from the deployed process.

6. The method of claim 5, wherein the one or more process parameters includes at least one of a number of ready processes and a process startup time.

7. The method of claim 6, wherein the curve function includes a factor that is determined using the process startup time.

8. The method of claim 7,
wherein the factor includes a plurality of factors, and
wherein each factor of the plurality of factors correlates to a range of process startup times of a plurality of process startup times.

9. The method of claim 8, wherein each factor increases in value as the range of process startup times increases.

10. The method of claim 1, wherein the metric is a first performance metric and the curved metric is a first performance metric, and further comprising:
receiving a second performance metric;
comparing the second performance metric to the pre-existing target;
determining, when the second performance metric is below the pre-existing target, to decrease the number of deployed processes based on a second curved metric;
receiving the second curved metric from the metrics server; and
decreasing, by the autoscaling controller, the number of deployed processes based on the second curved metric.

11. The method of claim 10, wherein the plurality of steps is a first plurality of steps, the curve function is a first curve function, and wherein receiving the second curved metric from the metrics server includes the metrics server executing a plurality of second steps comprising:
receiving the second performance metric from the data repository,
receiving the second curved metric,
wherein the second curved metric is generated by applying a second curve function to the second performance metric, and
wherein the second curve function scales the number of deployed processes, and
transmitting the second curved metric to the autoscaling controller.

12. A system comprising:
a computer processor;
a metrics server in communication with the computer processor;
a data repository in communication with the computer processor and storing:
a pre-existing target,
a curved metric, and
a curve function;
a deployed process in communication with the metrics server and the data repository and having:
a performance metric, and
a number of deployed processes;
an autoscaling controller which, when executed by the computer processor, performs at least one of increasing and decreasing the number of deployed processes; and
a server controller which, when executed by the computer processor:
receives the performance metric;
compares the performance metric to the pre-existing target; and
receives the curved metric,
wherein the curved metric is generated by applying a curve function to the performance metric, and
wherein the curve function prescales the number of deployed processes.

13. The system of claim 12, wherein the at least one of increasing and decreasing the number of deployed processes based on the curved metric includes calculating the number of deployed processes using the curved metric and the pre-existing target.

14. The system of claim 12, wherein the deployed process is a deployed pod,
wherein the deployed pod contains one or more containers with shared storage and network resources, and
wherein each container of the one or more containers includes code and runtimes to run an application workload.

15. The system of claim 12, wherein the curve function includes one or more process parameters.

16. The system of claim 15, wherein receiving the curved metric includes a plurality of steps comprising:
querying the data repository for the curved metric;
querying the data repository for the performance metric and the one or more process parameters; and
transmitting the curved metric to the autoscaling controller,
wherein the performance metric and the one or more process parameters are imported from the deployed process.

17. The system of claim 16, wherein the one or more process parameters includes at least one of a number of ready processes and a process startup time.

18. The system of claim 17, wherein the curve function includes a factor that is determined using the process startup time.

19. The system of claim 18,
wherein the factor includes a plurality of factors, and
wherein each factor of the plurality of factors correlates to a range of process startup times of a plurality of process startup times.

20. A method comprising:
receiving a performance metric,
wherein the performance metric is used by an autoscaling controller to scale a number of deployed processes by at least one of increasing the number of deployed processes in response to the performance metric exceeding a pre-existing target and decreasing the number of deployed processes in response to performance metric being below the pre-existing target,
comparing the performance metric to the pre-existing target;
determining, when the performance metric is below the pre-existing target, to decrease the number of deployed processes based on a curved metric;
receiving the curved metric,
wherein the curved metric is generated by applying a curve function to the performance metric, and
wherein the curve function prescales the number of deployed processes; and
decreasing, by the autoscaling controller, the number of deployed processes based on the curved metric.
